(19) United States
(12) Patent Application Publication
(10) Pub. No.: US 2008/0229355 A1
(43) Pub. Date: Sep. 18, 2008

(54) TELEVISION STATION, ASSOCIATED CONVENTIONS AND OTHER DEDICATED SERVICES FOR A DEMOGRAPHIC COMPRISING PERSONS FIFTY YEARS OLD AND OLDER

(76) Inventor: Fred Victorson, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 12/124,042

(22) Filed: May 20, 2008

Related U.S. Application Data
(63) Continuation-in-part of application No. 11/688,773, filed on Mar. 20, 2007.
Application No. 11/688,773 is a continuation-in-part of application No. 11/277,341, filed on Mar. 23, 2006.

(51) Int. Cl. H04N 7/08

(52) U.S. Cl. 725/35

(57) ABSTRACT

A television, cable or satellite channel dedicated to issues relevant to persons fifty years old or older is disclosed. The content of the channel involves programming on healthcare, politics, insurance and many related issues. Advertisements are also limited to goods and services directed to persons fifty years old and older. Indeed, one version limits advertisements to the subject matter of the programming during which the advertisement is shown. For example, during healthcare programming only healthcare related advertisements are shown. Interactive programming is also disclosed. The television channel is also used as a conduit for providing an avenue for members of the demographic to lodge concerns and complaints. Associated conventions dedicated to issues and concerns of persons fifty years or older may also be promoted during programming on the channel.

### CROSS REFERENCE OF RELATED APPLICATIONS

This application is a continuation-in-part of application Ser. No. 11/688,773 filed Mar. 20, 2007, which is a continuation-in-part of application Ser. No. 11/277,341 filed Mar. 23, 2006.

### FIELD OF THE INVENTION

The embodiments of the present invention relate to a television station dedicated to a demographic comprising persons fifty years old and older. More particularly, the embodiments relate to a television station, associated conventions and other services dedicated to the fifty and over demographic.

### BACKGROUND

Persons fifty and over form a large portion of the U.S. demographic. It includes senior citizens and baby boomers. Moreover, the fifty and over demographic will increase as life expectancy increases. Unfortunately, the demographic is often overlooked when it comes to services and other benefits.

For example, senior citizens are provided few advantages based on their age. Social security, discounts on goods and services and Medicare are the typical benefits provided to seniors. However, social security and Medicare are routinely in flux as the target of possible budget cuts. Clearly, society owes more to its seniors than it currently provides. Fortunately, there are individuals and companies throughout our society that desire to assist seniors but are unable to get the message to seniors in a routine and consistent manner. The same holds true for the fifty and over demographic.

Television is one medium that has burgeoned into a vast-reaching enterprise allowing the masses to entertain and educate themselves. Seemingly there are one or more channels to placate the needs of all segments of society. Sports channels, cooking channels, news channels, movie channels, animal channels, history channels and cartoon channels are only a few of the myriad of channels available to cable or satellite subscribers. To date, there are no channels dedicated to a specific segment of society and the problems and concerns they face.

A channel dedicated to the fifty and over demographic is advantageous as it provides a routine and easily located medium offering programming relevant to the issues facing the large numbers of persons falling into the fifty and over demographic. Moreover, as described in greater detail below, advertisers and content providers benefit by targeting a very large and wealthy segment of society.

It would also be advantageous to arrange routine conventions dedicated to the fifty and over demographic and their unique interests and concerns. In one embodiment, the conventions are held annually or semi-annually and are promoted via the dedicated fifty and over channel.

Thus, there is a need for a television station, associated conventions and other services dedicated to the issues facing the fifty and over demographic.

### SUMMARY

Accordingly, a first method embodiment of the present invention is directed to operating a dedicated channel comprising: developing content relevant to a demographic comprising persons fifty years old and older, said content including entertainment and educational programming; broadcasting the content over a radio or satellite frequency, or via a wire or cable, said content receivable and displayable on a display of a television, personal computer or hand-held device; and providing opportunities for third parties to place advertisements promoting goods and services wherein the advertisements are specifically related to subject matter of the programming during which the advertisements are shown.

Another method embodiment of the present invention is directed to operating a dedicated channel comprising: developing content relevant to a demographic comprising persons fifty years old and older, said content including entertainment and educational programming; broadcasting the content over a radio or satellite frequency, or via a wire or cable, said content receivable and displayable by a display on a television, personal computer or hand-held device; providing opportunities for third parties to place advertisements promoting goods and services wherein the advertisements are specifically related to subject matter of the programming during which the advertisements are shown; and broadcasting promotional and informative content regarding conventions dedicated to issues and concerns facing the demographic.

The content may be disseminated via radio or satellite signals receivable by electronic devices, such as televisions and personal computers. The content may also be disseminated over conventional cables connected to suitable electronic devices. The underlying purpose of the embodiments of the present invention is to provide a vehicle for persons fifty years old and older to passively receive entertainment programming, educational programming and access to goods and services. A second purpose is to provide a vehicle for persons fifty years old and older to become actively involved in the entertainment and education while being presented with relevant goods and services.

A convention aspect allows person fifty years old and older to gather in a common location (e.g., Las Vegas) such that they may interact with other similarly situated persons while interacting with various vendors providing goods and/or services directed to their demographic and their unique interests and concerns.

Other variations, embodiments and features of the present invention will become evident from the following detailed description, drawings and claims.

### BRIEF DESCRIPTION OF THE DRAWINGS

FIG. 1 illustrates a flow chart detailing one embodiment of the present invention;

FIG. 2 illustrates a programming chart detailing one day of sample programming; and

FIG. 3 illustrates a flow chart detailing an alternative embodiment of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

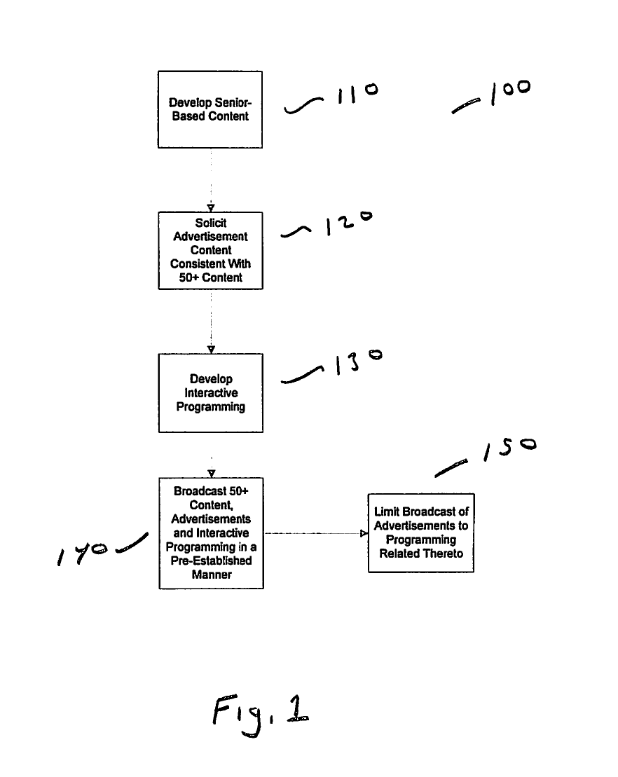

Reference is now made to the figures wherein like parts are referred to by like numerals throughout. FIG. 1 shows a flow chart 100 of a first embodiment of the present invention. Initially, at step 110, content relevant to persons fifty years old and older is developed. The content can come in any number of forms, including entertainment and educational programming. Issues relevant to persons fifty years old and older are plentiful and some are disclosed below. Heretofore, such content is not available in a single easily accessible location. As described below, the embodiments of the present invention fulfill this need any many others.

Political issues are very serious to persons fifty years old and older. Suitable political content may include candidate platforms, voting dates, voting locations and other political information. In one embodiment, the political information is also limited to issues facing persons fifty years old and older such that such persons are specifically educated on the issues of particular relevance to their demographic. Political content may be broader as well. For example, political content may include bills and other legislative measures which, if passed, may impact directly, or indirectly, persons fifty years old and older and their lifestyle.

Healthcare is arguably the single most important political issue to persons fifty years old and older. Medicare is one aspect of the healthcare system that is particularly relevant to seniors. The content related to Medicare may include means for securing Medicare, available coverage, procedures for utilizing Medicare and related issues. Importantly, with the new complicated Medicare procedures, the content may provide instructional information related to utilizing the same. Programming related to self-insurance, including means for securing self-insurance and scope of coverage, is also suitable. Self-insurance provides seniors with alternative and/or better coverage than Medicare alone.

Healthcare programming can be used to educate persons fifty years old and older on relevant diseases, diagnosis, remedies and prescription drugs. The programming may be very detailed thereby providing persons fifty years old and older with means for self-diagnosis. With seniors especially, early diagnosis is critical to overcoming medical problems and extending life expectancy. Another aspect of healthcare involves programming related to medical doctors, such as their qualifications, insurance requirements, etc.

Social security content may also be developed in conjunction with healthcare and Medicare. Social security programming, like Medicare programming, can assist seniors with the complexities and benefits and pitfalls of social security. Programming regarding the quality of local nursing homes and related care facilities can also be provided.

Other government agencies, such as the DMV and Veteran's Administration, may facilitate the development of content. For example, the DMV can develop content designed to assist persons fifty years old and older with renewing driver's licenses and locating the nearest DMV branch.

Another genre of programming can relate to educating persons fifty years old and older, especially seniors, regarding scams and similar offenses which have historically targeted this demographic. Entire shows may be dedicated to educating persons fifty years old and older with respect to known scams and the things to look for to identify new scams. Similarly, the programming may be used to educate the demographic regarding the downside of legal risks, like gaming. Low and middle class persons fifty years old and older can be tempted by slot machines and similar gaming devices. Accordingly, a program can be dedicated to counseling persons fifty years old and older on the pitfalls to such activities.

Programming related to cooking can be developed to assist persons fifty years old and older with preparing inexpensive and healthy meals. Such programming can be developed to assist persons fifty years old and older with eating healthy thereby working hand-in-hand with the healthcare content.

Social programming is another invaluable service that may be presented via the embodiments of the present invention. Social programming can be used to advise persons fifty years old and older of dates and times for singles gatherings, lessons with arts and crafts, game play (e.g., bridge and bingo), etc.

Sitcoms, movies, game shows and similar theatrical material of the appropriate subject matter may provide a foundation for entertainment content directed to persons fifty years old and older.

Programming can be based on any desired or suitable content such as available housing, employment, volunteer opportunities, exercise and hygiene. Such a dedicated channel is ideal for persons fifty years old and older. Many in this demographic are often immobile and unskilled with computers so that a dedicated television channel provides a natural medium to which a majority of this demographic have access. Programming of particular relevance can be taped or otherwise stored for later viewing.

To enhance the experience for persons fifty years old and older, at step 120, advertising content commensurate with the entertainment and educational programming is developed. Advertisements are predicated on benefiting persons fifty years old and older by presenting goods and services especially useful for this demographic. Advertisements for goods may promote medicines, food and clothing attractive for persons fifty years old and older. Advertisements for services may promote tax preparation, healthcare, insurance and related services. Indeed, the goods and services which may be promoted are limitless as long as they are meaningful to persons fifty years old and older. In one embodiment, given the constraints on mobility of seniors, the advertisements may be related to local providers of goods and services. In other words, while some advertisements may be national in scope, a majority of the advertisements may be local in nature to allow viewing seniors to take first hand advantage of the same.

In one embodiment, as shown at 150, the advertisements relate to the programming being disseminated. That is, during healthcare programming, only healthcare advertisements are shown. In this manner, persons fifty years old and older are able to determine in a convenient fashion when advertisements of interest will be aired. Such an embodiment permits persons fifty years old and older to develop a programming schedule of particular relevance to their needs. This embodiment is also beneficial to the advertisers since the advertisers are able to target a very specific demographic. No such system is currently employed. While advertisers currently attempt to target certain demographics based on programming, they do it in an inexact manner. For example, during soap operas, advertisements typically target females because females are more likely than males to watch soap operas. However, there is no assurance that the females will be interested in the products or services being advertised. Contrarily, this embodiment of the present invention provides advertisers with greater certainty as the viewers are watching programming directly related to the advertised product or service. Thus, the advertiser knows in advance that the viewers are interested in the premise or concept behind the product or service.

At step 130, interactive programming is developed. Interactive programming consists of programming designed to allow persons fifty years old and older to participate, at some level, in the programming. In one example, a live show targeting persons fifty years old and older is produced and filmed for live or taped airing at a local facility frequented by persons fifty years old and older. Casinos, bingo halls or similar facilities are suitable choices. Such facilities cater to persons fifty years old and older and will benefit financially by attracting large numbers of persons to watch and participate in the programming depending on the programming content. Specifically, a talk show dedicated to persons fifty years old and older may be taped in a local casino allowing persons fifty years old and older persons fifty years old and older to form an audience and allowing the casino to increase foot traffic.

Further interactive programming provides an avenue for persons fifty years old and older to utilize the channel as a conduit to express concerns or complaints. Toll free numbers provided during various programs allow persons fifty years old and older to contact live operators to express concerns or complaints, typically related to the programming during which the toll free number is distributed. In one example, seniors are able to contact a toll free number regarding Medicare issues, such as double billing. Personnel at the channel may then pass on the information to the corresponding state and/or federal government agency. Thus, the channel acts like a go between such that seniors do not have to waste time or energy maneuvering through conventional, inefficient methods of contacting the agency directly. In this manner, the government or other entities benefit directly from the reporting provided by the seniors. Any industry interested in receiving unbiased customer feedback can utilize the dedicated channel to collect feedback of the targeted demographic via the channel.

At step 140, programming is broadcast, via wired and/or wireless means, to television sets and other electronic devices. The programming can be received by computers, cell phones, personal digital assistants and similar hand-held devices. In one embodiment, the content, selected by the person fifty years old and older, is routinely e-mailed or transmitted in text and/or video format to electronic devices possessed by the person. For example, a senior may select Medicare updates. As a result, the senior receives Medicare updates via e-mail or other transmission to the devices selected by the senior. This embodiment allows the person to easily receive relevant information without having to conduct Internet searches, sift through written documents or otherwise attempt to locate the relevant information. The information may also be mailed for those persons whom do not own a computer of are not computer savvy.

Money-raising promotions directed at persons fifty years old and older may also be advertised and/or disseminated over the channel airing the content. Promotions may be based on golf outings, bake sales and the like. The promotions may be designated for specific geographic regions, classes of persons fifty years old and older or general charities. In this manner, persons fifty years old and older are able to participate in fund-raising activities or become educated of the benefits associated with fund-raising efforts.

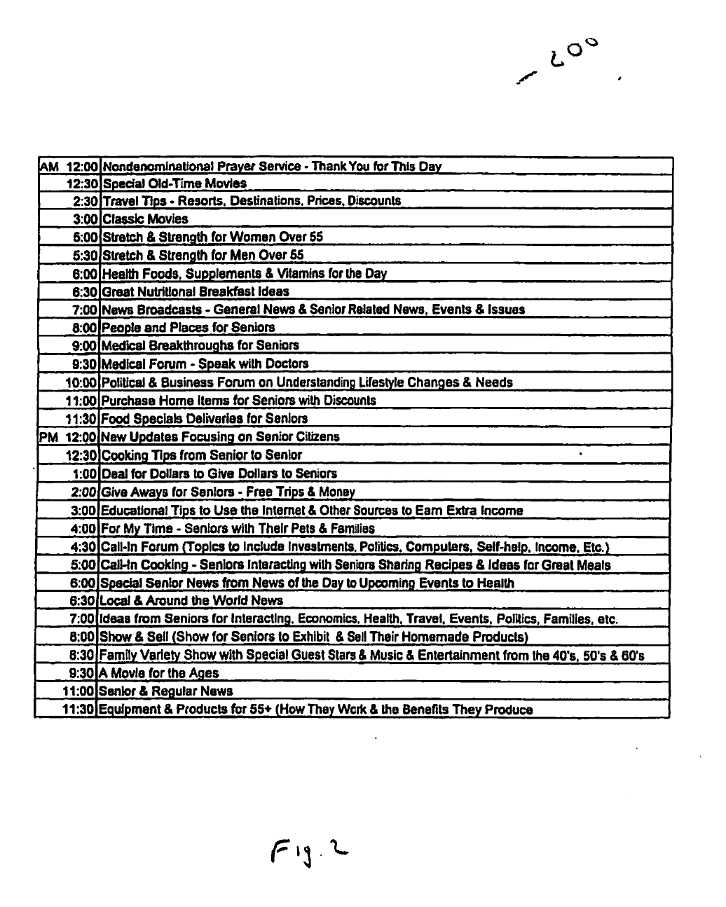

FIG. 2 shows a proposed programming schedule 200 for a single day. As detailed herein, the content is directed to persons fifty years old and older. While the schedule 200 depicts 24 hour programming, programming during low peak hours (1:00 am-4:00 am) may include reruns or infomercials pitching products useful to persons fifty years old and older. Moreover, the schedule 200 shown is directed to seniors but it will be understood that programming for persons fifty years old and older is similar. The channel may also be down during the no-peak hours such that no programming is shown.

Since programming consists of subject matter pertinent to the needs of persons fifty years old and older on an ongoing basis, current events and other vital information happening on a day-to-day basis may also create the need for a fluid programming schedule that contains operating changes and additions as required. In other words, although a programming schedule is set, it is subject to change should important information relevant to persons fifty years old and older become available.

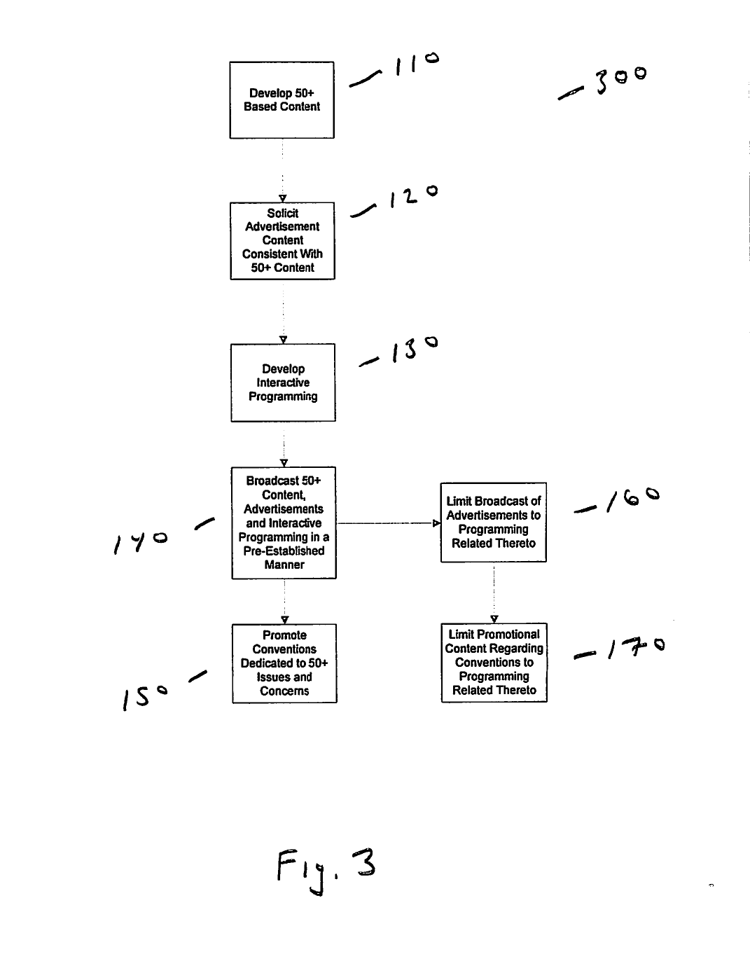

FIG. 3 shows a flow chart 300 detailing another embodiment of the present invention whereby at 160 one or more conventions tailored to issues and concerns of persons fifty years old and older are promoted on or via the dedicated channel. In this manner, persons fifty years old and older are assured of being notified of the convention and the vendors that will be in attendance. Promotions are used to encourage attendance based on the vendors and functions being organized at the convention. Otherwise, without the dedicated channel, many persons fifty years old and older may never know that a convention dedicated to relevant issues and concerns was scheduled. For example, many seniors are not computer savvy and would fail to learn of the convention via the Internet. Also, many seniors view traditional mail with some skepticism as many scams directed at seniors are undertaken via mail. Consequently, with the method disclosed herein seniors are able to gather accurate and reliable content regarding the convention.

Like above, at 170 it is also advantageous to promote certain features (e.g., vendors, goods or services) during specific programming related thereto. For example, if a vendor dedicated to selling life insurance is committed to being at the convention, a promotional ad regarding the vendor may be aired during a televised show dedicated to life insurance for persons fifty years old and older. Therefore, the vendor selling life insurance is sure to target the specific demographic of interest. Similarly, those persons fifty years old and older interested in life insurance are more likely to become aware of the convention. Information may also be transmitted to persons fifty years old and older via e-mail or text message or with known methodologies.

The conventions may take place annually or semi-annually in any location, including Las Vegas, Orlando or Phoenix. International destinations may also be utilized to host the conventions. The conventions are dedicated to providing information, goods and services that are of specific interest to persons fifty years old and older. In addition, the conventions provide an ideal retreat for persons fifty years old and older to congregate to tackle similar concerns, address similar issues or just discuss issues they have in common. The conventions are also used to promote the dedicated television channel. For example, besides advertisements displayed at the convention location, the television channel retains a booth and mans it with staff able to explain the television channel to attendees.

By combining the television channel and convention, persons fifty years old and older are benefited tremendously, because they like no other demographic, are more likely to find it difficult to digest the vast amounts of information disseminated on a daily basis. Gathering and disseminating information relevant to persons fifty years old and older via a television channel and associated conventions is an efficient platform to target the demographic. Moreover, convention attendee registrations provide data that is used to better define the interests and concerns of persons fifty years old and older by race, creed, gender, age, etc. Based on the collected data, television channel programming and the convention topics can be adjusted to better fit the interests and concerns of the persons fifty years old and older.

In another embodiment, discounted services are offering to persons fifty years old and older. In one embodiment, credit cards having lower interest rates (e.g., 10%-12%) are offered to persons fifty years old and older which have quality credit. During times when the dollar is weak, foreign banks may be used to back the credit cards.

Content created for the dedicated channel may also be licensed to other channels for repeat broadcasting. Such licensing not only generates revenue for the dedicated channel but also advertises the channel to attract viewers and/or subscribers. Shows aired on the dedicated channel may also be sponsored by third parties.

It is also envisioned that merchandise branded with the dedicated channel will generate revenue for the channel. Such merchandise may be sold via the channel, Internet, catalogs, retail outlets and the like.

Although the invention has been described in detail with reference to several embodiments, additional variations and modifications exist within the scope and spirit of the invention as described and defined in the following claims.

I claim:

1. A method of operating a dedicated channel comprising:
developing content relevant to a demographic comprising persons fifty years old and older, said content including entertainment and educational programming;
broadcasting the content over a radio or satellite frequency, or via a wire or cable, said content receivable and displayable on a display of a television, personal computer or hand-held device; and
providing opportunities for third parties to place advertisements promoting goods and services wherein the advertisements are specifically related to subject matter of the programming during which the advertisements are shown.

2. The method of claim 1 further comprising disseminating content related to healthcare, politics, housing, governmental agencies, cooking and social activities.

3. The method of claim 1 further comprising disseminating content comprising sitcoms, game shows and movies.

4. The method of claim 1 further comprising providing interactive programming.

5. The method of claim 1 further comprising disseminating the content via mail and/or e-mail.

6. The method of claim 5 further comprising providing means for said persons fifty years old and older to dictate the subject matter of the mail and/or e-mail.

7. The method of claim 1 further comprising offering credit cards to persons fifty years old and older, said credit cards having reduced interest rates.

8. A method of operating a dedicated channel comprising:
developing content relevant to a demographic comprising persons fifty years old and older, said content including entertainment and educational programming;
broadcasting the content over a radio or satellite frequency, or via a wire or cable, said content receivable and displayable by a display on a television, personal computer or hand-held device;
providing opportunities for third parties to place advertisements promoting goods and services wherein the advertisements are specifically related to subject matter of the programming during which the advertisements are shown; and
broadcasting promotional and informative content regarding conventions dedicated to issues and concerns facing the demographic.

9. The method of claim 8 further comprising disseminating content related to healthcare, politics, housing, governmental agencies, cooking and social activities.

10. The method of claim 8 further comprising disseminating content comprising sitcoms, game shows and movies.

11. The method of claim 8 further comprising disseminating content via mail and/or e-mail.

12. The method of claim 11 further comprising providing means for persons fifty years old and older to select the subject matter of received mail and/or e-mail.

13. The method of claim 8 further comprising offering credit cards to persons fifty years old and older, said credit cards having reduced interest rates.

14. A method of operating a dedicated senior citizen channel comprising;
developing senior-based content, including entertainment and educational programming;
broadcasting the senior-based content over a pre-established radio or satellite frequency, or via a cable, said content receivable and displayable by a television set, computer or hand-held device;
providing opportunities for third parties to place advertisements promoting senior-related goods and services wherein the advertisements are specifically related to subject matter of the programming during which the advertisements are shown;
broadcasting promotional and informative content regarding associated conventions dedicated to senior related issues and concerns wherein said promotional and informative content is specifically related to subject matter of the programming during which the promotional and informative content is shown.
disseminating senior-based content, including the promotional and informative content regarding the conventions, via mail and/or e-mail.

15. The method of claim 14 further comprising disseminating senior-based content related to healthcare, politics, housing, governmental agencies, cooking and social activities.

16. The method of claim 14 further comprising disseminating senior-based content comprising sitcoms, game shows and movies.

17. The method of claim 1 further comprising providing interactive programming.

18. The method of claim 14 further comprising providing means for persons fifty years old and older to dictate the subject matter of the mail and/or e-mail.

19. The method of claim 14 further comprising providing the e-mails via a wired and/or wireless system.
